(19) United States
(12) Patent Application Publication
(10) Pub. No.: US 2026/0361938 A1
(43) Pub. Date: Nov. 12, 2026

(54) HYBRID PLAYBACK PROCESSING METHOD AND SYSTEM, ELECTRONIC APPARATUS AND COMPUTER-READABLE STORAGE MEDIUM

(71) Applicant: SHANGHAI BILIBILI TECHNOLOGY CO., LTD., Shanghai (CN)

(72) Inventors: Zhengfei Yang, Shanghai (CN); Wei Jiang, Shanghai (CN); Lizhuang Shi, Shanghai (CN)

(21) Appl. No.: 19/100,235

(22) PCT Filed: Jul. 5, 2023
(86) PCT No.: PCT/CN2023/105786

§ 371 Date: Jan. 31, 2025

(30) Foreign Application Priority Data
Aug. 2, 2022 (CN) 202210923643.8

(51) Int. Cl. H04N 21/2387; H04N 21/262; H04N 21/472

(52) U.S. Cl. CPC H04N 21/2387; H04N 21/26258; H04N 21/47217

(57) ABSTRACT

The application discloses a hybrid playback processing method. The method includes: abstracting each service video into basic video data according to a preset rule, generating a playback task queue, and submitting the play back task queue to a player; reading, by the player, a current first playback task from the playback task queue, obtaining first basic video data corresponding to the first playback task, loading a corresponding first panel instance from a panel cache pool according to the first playback task, and playing the first basic video data by using the first panel instance; and when a second playback task is switched to, resetting the first basic video data in the player, obtaining second basic video data corresponding to the second playback task, loading a corresponding second panel instance from the panel cache pool according to the second playback task, and playing the second basic video data by using the second panel instance. The application further discloses a hybrid playback processing system, an electronic apparatus, and a computer-readable storage medium. Therefore, hybrid playback of different playback modes and player reusing can be implemented.

The application claims priority to Chinese Patent Application No. 202210923643.8, filed with the China National Intellectual Property Administration on Aug. 2, 2022 and entitled “HYBRID PLAYBACK PROCESSING METHOD AND SYSTEM”, which is incorporated herein by reference in its entirety.

### TECHNICAL FIELD

The application relates to the field of video playback technologies, and in particular, to a hybrid playback processing method and system, an electronic apparatus, and a computer-readable storage medium.

### BACKGROUND

With popularization and development of computer technologies, a video playback platform includes increasingly more service channels. For example, a serialized anime, a documentary, a movie, and livestreaming are different services (playback modes), and belong to different channel pages.

The inventor is aware that in the video industry, there is currently no play back mode that can support hybrid playback of different playback modes and player reusing. To be specific, a user needs to switch to different modes (or scenarios), for example, enter pages corresponding to different services to click corresponding videos, to experience video playback modes of different services. In this manner, viewing experience of the user is fractured, and user experience is not good.

### SUMMARY

A main objective of the application is to provide a hybrid playback processing method and system, an electronic apparatus, and a computer-readable storage medium, to resolve an issue about how to carry hybrid playback of different playback modes and implement player reusing.

To achieve the foregoing objective, a hybrid playback processing method is provided in an embodiment of the application. The method includes:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

Optionally, the abstracting each service video into basic video data according to a preset rule includes:
obtaining a play back task definition provided by the player, and abstracting the service video into the basic video data according to a rule corresponding to the play back task definition, wherein the basic video data includes no service logic.

Optionally, the method further includes:

When playing a service video of a service type for a first time, the player creates a panel instance corresponding to the service type, caches the panel instance in the panel cache pool, and stores a mapping relationship between the service type and the panel instance.

Optionally, the loading a corresponding first panel instance from a panel cache pool according to a service type to which a first service video corresponding to the first playback task belongs includes:
querying panel instance information corresponding to the service type from the mapping relationship, and finding and loading the first panel instance from the panel cache pool according to queried information.

Optionally, the player creates only one player instance, and plays, in the player instance, the basic video data corresponding to the service video of the service type by using the panel instance corresponding to each service type.

Optionally, the method further includes:
when the player triggers a status update, transmitting a status update message to a currently bound service party, wherein the currently bound service party is a service party corresponding to a service video currently being played.

Optionally, the method further includes:
when playing the first service video is switched to playing the second service video, unbinding a service party corresponding to the first service video from the player, and binding the player to a service party corresponding to the second service video.

Optionally, the player is a card-style player, and plays the service video by using a small-window view.

Optionally, the method further includes:
receiving a preset operation of a user, and adding or deleting a small-window view corresponding to the player in a current display interface according to the preset operation.

Optionally, the method further includes:
when the small-window view is deleted, clearing a panel instance cached in the panel cache pool.

In addition, to achieve the foregoing objective, a hybrid playback processing system is further provided in an embodiment of the application. The system includes:
a management module, configured to abstract each service video into basic video data according to a preset rule, generate a playback task queue, and submit the playback task queue to a player; and
a playback module, configured to: control the player to read a current first play back task from the playback task queue, obtain first basic video data corresponding to the first playback task, load a corresponding first panel instance from a panel cache pool according to a service type to which a first service video corresponding to the first play back task belongs, and play the first basic video data by using the first panel instance.

The playback module is further configured to: when a second playback task is switched to, reset the first basic video data in the player, obtain second basic video data corresponding to the second playback task, load a corresponding second panel instance from the panel cache pool according to a service type to which a second service video corresponding to the second playback task belongs, and play the second basic video data by using the second panel instance.

To achieve the foregoing objective, an electronic apparatus is further provided in an embodiment of the application, including a memory, a processor, and computer-readable instructions stored in the memory and capable of running on the processor, wherein the computer-readable instructions are executed by the processor to implement the following steps:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

To achieve the foregoing objective, a computer-readable storage medium is further provided in an embodiment of the application, storing computer-readable instructions, wherein the computer-readable instructions are executed by a processor to implement the following steps:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

According to the hybrid playback processing method and system, the electronic apparatus, and the computer-readable storage medium provided in the embodiments of the application, the player and service data can be deeply decoupled, the service video is abstracted into most basic data, which is submitted to the player, and only one player instance is created. Corresponding service videos are played by using panel instances corresponding to different service types, so that hybrid playback of different playback modes (videos of different service types) and player reusing are implemented without switching between different pages and scenarios, thereby ensuring seamless switching between a plurality of services and ensuring performance, and implementing best user experience.

### BRIEF DESCRIPTION OF DRAWINGS

FIG. 1 is a diagram of an architecture of an application environment for implementing various embodiments of the application;

FIG. 2 is a diagram of an architecture of a client in FIG. 1;

FIG. 3 is a flowchart of a hybrid playback processing method according to Embodiment 1 of the application;

FIG. 4 is a schematic diagram of a small-window view according to the application;

FIG. 5 is a flowchart of a hybrid playback processing method according to Embodiment 2 of the application;

FIG. 6 is a schematic diagram of a hardware architecture of an electronic apparatus according to Embodiment 3 of the application; and

FIG. 7 is a schematic diagram of modules in a hybrid playback processing system according to Embodiment 4 of the application.

### DESCRIPTION OF EMBODIMENTS

To make the objectives, technical solutions, and advantages of the application clearer and more comprehensible, the following further describes the application in detail with reference to the accompanying drawings and the embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

FIG. 1 is a diagram of an architecture of an application environment for implementing various embodiments of the application. The application may be applied to an application environment that includes but is not limited to a client 2, a server 4, and a network 6.

The client 2 is configured to display a video playback page to a user and receive various operations of the user. The client 2 may be a terminal device, for example, a personal computer (PC), a mobile phone, a tablet computer, a portable computer, or a wearable device.

The server 4 is configured to provide data and technical support for the client 2. The server 4 may be a computing device, for example, a rack server, a blade server, a tower server, or a cabinet server, may be an independent server, or may be a server cluster including a plurality of servers.

The network 6 may be a wireless or wired network, for example, an Intranet, the Internet, a global system for mobile communication (GSM), wideband code division multiple access (WCDMA), a 4G network, a 5G network, Bluetooth, or Wi-Fi. The server 4 is communicatively connected to one or more clients 2 by using the network 6, to perform data transmission and exchange.

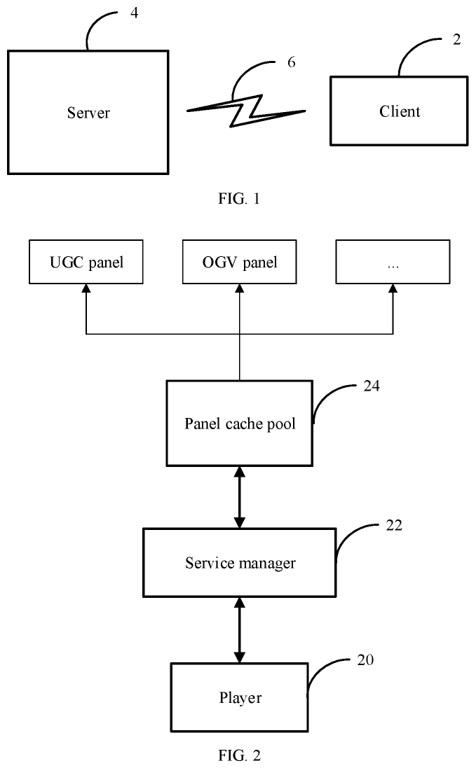

Further, refer to FIG. 2. FIG. 2 is a diagram of an architecture of the client 2. In FIG. 2, the client 2 includes but is not limited to a player 20, a service manager 22, and a panel cache pool 24.

Currently, video playback may include different playback modes (service types), such as livestreaming, user generated content (UGC, for example, a series of video content uploaded by an uploader) on-demand, occupationally generated video (OGV, for example, a serialized anime, a TV series, a movie, and a documentary) on-demand, and pay per click (PPC, pay according to performance, that is, pay-per-click advertising) on-demand. However, in an existing video playback platform, hybrid playback of a plurality of play back modes and player reusing cannot be implemented. The user needs to tediously switch to scenarios corresponding to different playback modes (for example, click videos on different service channel pages) to experience different video playback modes.

To avoid the foregoing disadvantage of fractured user experience, in the application, a multi-service hybrid play back mode is used, which can implement hybrid play back of different playback modes and player reusing without switching between different pages and scenarios, thereby implementing best user experience (video playback/consumption experience). The hybrid play back refers to playing videos of a plurality of different service types in a same video container (player), and automatically updating a related user interface (UI) according to service customization.

The player 20 provides a playback task definition and a task submission interface, and can play a service video by using some simple configurations. There is only one card-style player instance in the whole hybrid playback process. All service videos are abstracted into basic data (including no service logic) according to a rule and given to the player 20 for consumption.

Preferably, the player 20 is a card-style player. The card-style player is a lightweight play back framework of a video, and plays the service video by using a small-window view. Small-window playback means that video playback is carried by using a floating small window inside an application (APP) or outside the APP. The user can perform another operation (for example, chatting on WeChat, shopping, and reading news) while watching a video.

The service manager 22 serves as a bridge between the player 20 and various type of service logic in a video playback process, and is mainly configured to:
(1) keep a mapping relationship between a service type and a panel instance, distinguish between different service types, and load a corresponding panel instance from the panel cache pool 24;
(2) schedule related functions of proxy interfaces injected by service parties, wherein when the player 20 triggers a specific status update (for example, pause, initial playing, or a play back failure due to a data error), a status update message of the player 20 can be accurately transmitted to a corresponding service party; and when service switching occurs, an old service proxy is unbound in a timely manner and the service party is notified, and then a new service proxy is bound, to avoid confusion in playback control rights;
(3) when service switching occurs, reset old data in the player 20 and submit new data; and
(4) add or delete a small-window view according to a user operation (that is, create or delete a card-style player).

The panel cache pool 24 is configured to cache panel instances (for example, a UGC panel and an OGV panel) of a plurality of different service types in a hybrid playback scenario. In a hybrid playback process, when a video of a service type is played for a first time, a panel instance of the service type is created and placed in the panel cache pool 24 for subsequently reusing in a same service type. Only one panel instance is created for one service type at most, thereby effectively avoiding performance waste.

### Embodiment 1

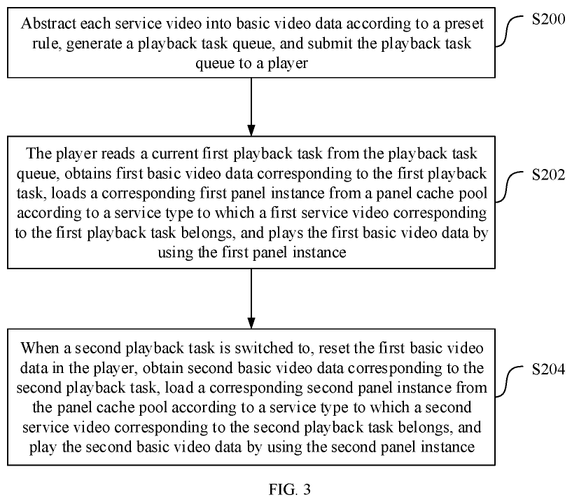

FIG. 3 is a flowchart of a hybrid playback processing method according to Embodiment 1 of the application. It may be understood that the flowchart in the method embodiment is not used to limit a sequence of performing steps. Some steps in the flowchart may alternatively be added or deleted as required. The method may be executed by a client or a server. The following describes the method by using the client as an execution body.

The method includes the following steps.

S200. Abstract each service video into basic video data according to a preset rule, generate a playback task queue, and submit the playback task queue to a player.

In this embodiment, a multi-service hybrid playback mode is used to implement hybrid play back of different playback modes and player reusing.

First, it is necessary to deeply decouple the player and service video data. Service logic included is injected in a proxy manner, which is actually processed by a service party. In this processing manner, an initial playing process of the player is simplified. Each-time playback is abstracted by a service manager into a pure playback task including no service logic, and then submitted to the player. When the player switches between different playback tasks, it is unnecessary to repeatedly perform creating and destroying. Instead, a same playback instance is reused and necessary status clearing is performed, thereby ensuring seamless switching between a plurality of services and further ensuring performance.

The player provides a playback task definition and a task submission interface. The playback task is defined as a minimum data set that can be played, and a video mode, an attribute, and the like are specified, which is equivalent to a protocol between the player and the service party. The service manager obtains the playback task definition provided by the player, abstracts, according to a rule corresponding to the playback task definition, each service video that needs to be played into basic video data, generates a playback task queue, and then submits the playback task queue to the player by using the interface. The basic video data includes no service logic.

In this embodiment, a user may select, in a form of adding a plurality of service videos in each service channel to a specified favorites folder or the like, a service video that needs to be played. For example, the user collects 100 service videos in the favorites folder, all of which are played in sequence. The 100 service videos are simultaneously submitted to the service manager. The service manager abstracts the 100 service videos, generates a playback task queue, and submits the play back task queue to the player for consumption.

It should be noted that the service manager may abstract all service videos in the playback task queue in advance and submit basic video data. Alternatively, when a service video is switched to, the service manager abstracts the service video and submits basic video data. Usually, abstraction is performed when a service video is switched to, to avoid performance waste.

S202. The player reads a current first playback task from the playback task queue, obtains first basic video data corresponding to the first playback task, loads a corresponding first panel instance from a panel cache pool according to a service type to which a first service video corresponding to the first playback task belongs, and plays the first basic video data by using the first panel instance.

In this embodiment, when playing a service video of a service type for a first time, the player creates a panel instance corresponding to the service type, caches the panel instance in the panel cache pool, and stores a mapping relationship between the service type and the panel instance.

The mapping relationship is stored in a database in a key-value (K-V) manner, and includes a service type name and corresponding panel instance information (for example, a cache address in the panel cache pool) and the like. Every time a playback task is executed, panel instance information corresponding to the service type is queried from the mapping relationship, and then the panel instance is found and loaded from the panel cache pool according to the queried information. For example, panel instance information corresponding to the service type to which the first service video belongs is queried from the mapping relationship, and the first panel instance is found and loaded from the panel cache pool according to the queried information.

In another embodiment, all panel instances of various service types may be cached in the panel cache pool in advance. When a playback task of one of the service types is executed, a corresponding panel instance is found from the panel cache pool for loading. Details are not described herein again.

S204. When a second play back task is switched to, reset the first basic video data in the player, obtain second basic video data corresponding to the second playback task, load a corresponding second panel instance from the panel cache pool according to a service type to which a second service video corresponding to the second playback task belongs, and play the second basic video data by using the second panel instance.

It should be noted that the player creates only one player instance in a hybrid play back process, consumes a playback task in the play back task queue, and plays, in the player instance, the basic video data corresponding to the service video of the service type by using the panel instance corresponding to each service type.

When play back task switching occurs, old data in the player is reset and new data is submitted. For example, when the first service video is switched to the second service video, the first basic video data corresponding to the first service video in the player is reset, and the second basic video data corresponding to the second service video is submitted. Specifically, the switching may be manually switching a video by the user, automatically playing a next video in a playlist, or the like.

Then, the player loads the corresponding second panel instance from the panel cache pool according to the service type to which the second service video corresponding to the second playback task belongs, and plays the second basic video data by using the second panel instance.

Specifically, the player queries, from the mapping relationship, panel instance information corresponding to the service type to which the second service video belongs, and then finds and loads the second panel instance from the panel cache pool according to the queried information.

Preferably, the player is a card-style player, and plays the service video by using a small-window view. In another embodiment, the play back task may be played by using any other feasible playback form. Currently, the card-style player (small-window playback) is a relatively good implementation, and costs of other implementations are relatively high.

In an optional embodiment, a preset operation of the user (for example, clicking “play” in the specified favorites folder/clicking a close button on a small window) may be further received, and a small-window view corresponding to the player is added or deleted (that is, a card-style player is created or deleted) on a current display interface according to the preset operation.

In an optional embodiment, when the small-window view is deleted, the panel instance cached in the panel cache pool further needs to be cleared to free up storage space.

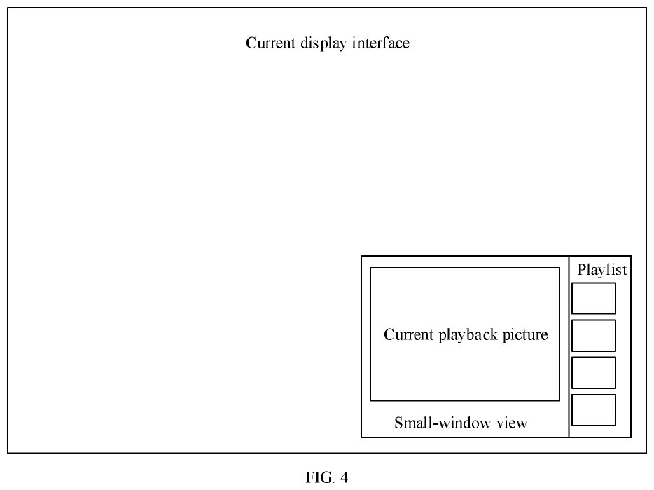

FIG. 4 is a schematic diagram of the small-window view. The small-window view (the card-style player) is created at any location (for example, a lower right corner) of the current display interface. The service manager abstracts a plurality of service videos (played in sequence) placed in the specified favorites folder by the user to generate a playback task queue (corresponding to a playlist in the figure) and submits the play back task queue to the card-style player. The card-style player consumes a playback task in the playback task queue, and plays a corresponding service video by using a panel instance of a service type corresponding to each playback task. When the user clicks, in the playlist, to switch to a next video, or the next video is automatically played in the playlist, the card-style player reuses the created play back instance and plays the next video by using a panel instance corresponding to the next video.

According to the hybrid play back processing method provided in this embodiment, the player and service data can be deeply decoupled, the service video is abstracted into most basic data, which is submitted to the player, and only one player instance is created. Corresponding service videos are played by using panel instances corresponding to different service types, so that hybrid play back of different playback modes (videos of different service types) and player reusing are implemented without switching between different pages and scenarios, thereby ensuring seamless switching between a plurality of services and ensuring performance, and implementing best user experience.

### Embodiment 2

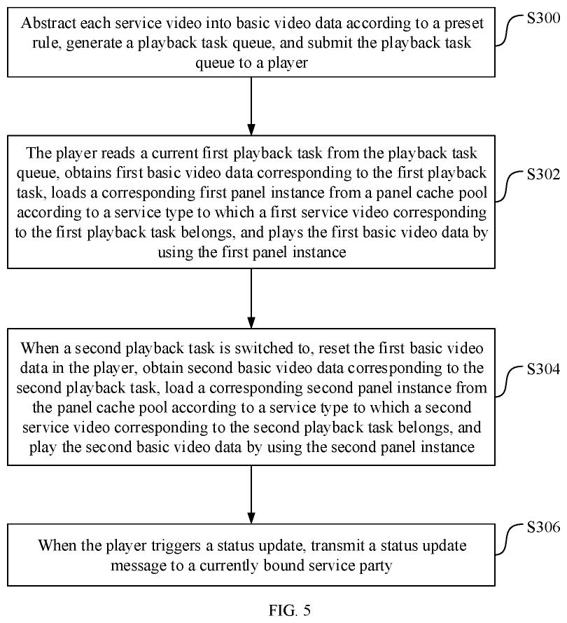

FIG. 5 is a flowchart of a hybrid playback processing method according to Embodiment 2 of the application. In Embodiment 2, based on Embodiment 1, the hybrid playback processing method further includes step S306. It may be understood that the flowchart in this method embodiment is not used to limit a sequence of performing steps. Some steps in the flowchart may alternatively be added or deleted as required.

The method includes the following steps.

S300. Abstract each service video into basic video data according to a preset rule, generate a playback task queue, and submit the playback task queue to a player.

The player provides a playback task definition and a task submission interface. A service manager obtains the play back task definition provided by the player, abstracts, according to a rule corresponding to the play back task definition, each service video that needs to be played into basic video data, generates a playback task queue, and then submits the play back task queue to the player by using the interface. The basic video data includes no service logic.

S302. The player reads a current first playback task from the playback task queue, obtains first basic video data corresponding to the first playback task, loads a corresponding first panel instance from a panel cache pool according to a service type to which a first service video corresponding to the first playback task belongs, and plays the first basic video data by using the first panel instance.

In this embodiment, when playing a service video of a service type for a first time, the player creates a panel instance corresponding to the service type, caches the panel instance in the panel cache pool, and stores a mapping relationship between the service type and the panel instance. Every time a playback task is executed, panel instance information corresponding to the service type is queried from the mapping relationship, and then the panel instance is found and loaded from the panel cache pool according to the queried information. For example, panel instance information corresponding to the service type to which the first service video belongs is queried from the mapping relationship, and the first panel instance is found and loaded from the panel cache pool according to the queried information.

S304. When a second play back task is switched to, reset the first basic video data in the player, obtain second basic video data corresponding to the second playback task, load a corresponding second panel instance from the panel cache pool according to a service type to which a second service video corresponding to the second playback task belongs, and play the second basic video data by using the second panel instance.

It should be noted that the player creates only one player instance in a hybrid play back process, consumes a playback task in the playback task queue, and plays, in the player instance, the basic video data corresponding to the service video of each service type by using the panel instance corresponding to the service type.

When play back task switching occurs, old data in the player is reset and new data is submitted. For example, when the first service video is switched to the second service video, the first basic video data corresponding to the first service video in the player is reset, and the second basic video data corresponding to the second service video is submitted. Specifically, the switching may be manually switching a video by a user, automatically playing a next video in a playlist, or the like.

Then, the player loads the corresponding second panel instance from the panel cache pool according to the service type to which the second service video corresponding to the second playback task belongs, and plays the second basic video data by using the second panel instance.

Specifically, the player queries, from the mapping relationship, panel instance information corresponding to the service type to which the second service video belongs, and then finds and loads the second panel instance from the panel cache pool according to the queried information.

Preferably, the player is a card-style player, and plays the service video by using a small-window view.

In an optional embodiment, a preset operation of the user may be further received, and a small-window view corresponding to the player is added or deleted (that is, a card-style player is created or deleted) on a current display interface according to the preset operation.

In an optional embodiment, when the small-window view is deleted, the panel instance cached in the panel cache pool further needs to be cleared to free up storage space.

S306. When the player triggers a status update, transmit a status update message to a currently bound service party.

The currently bound service party is a service party corresponding to a service video currently being played.

The service manager is responsible for interaction with each service party. When the player plays a video of a service type, the service party performs monitoring and registers with the service manager to form a binding relationship with the player. When the player triggers a specific status update (pause, initial playing, a playback failure due to a data error, or the like), the service manager sends the status update message of the player to the currently bound service party.

When a video of another service type is switched to, an old service proxy is unbound in a timely manner and the service party is notified (that the status update message is no longer sent to the service party), and then a new service proxy is bound, to avoid confusion in play back control rights.

Specifically, when the first service video is played, a service party corresponding to the first service video is bound, and the status update message of the player is sent to the service party. When playing the first service video is switched to playing the second service video, the service party corresponding to the first service video is unbound from the player, and the player is bound to a service party corresponding to the second service video.

According to the hybrid play back processing method provided in this embodiment, the player and service data can be deeply decoupled, the service video is abstracted into most basic data, which is submitted to the player, and only one player instance is created. Corresponding service videos are played by using panel instances corresponding to different service types, so that hybrid playback of different playback modes (videos of different service types) and player reusing are implemented without switching between different pages and scenarios, thereby ensuring seamless switching between a plurality of services and ensuring performance, and implementing best user experience. In addition, interactive scheduling between the player and the service party can be effectively managed, and the status update message of the player is accurately transmitted to the currently bound service party. In addition, when service switching occurs, an old service party is unbound in a timely manner and a new service party is bound, to avoid confusion in playback control rights.

### Embodiment 3

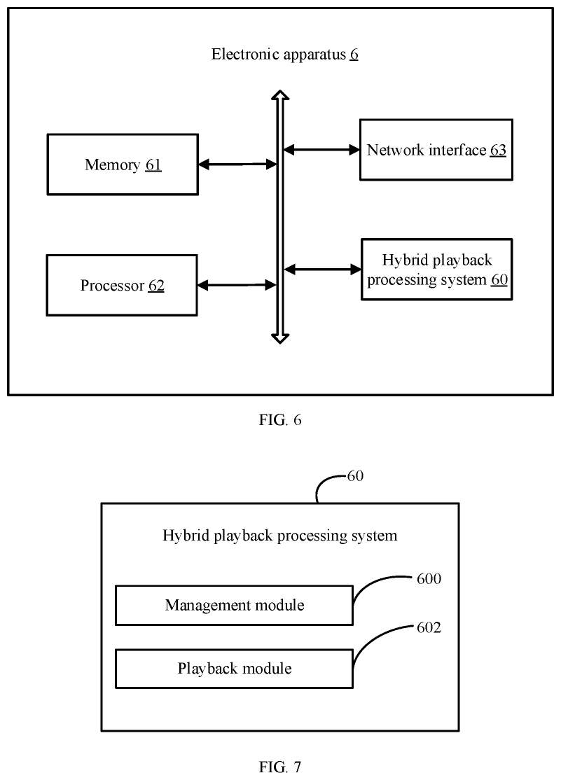

FIG. 6 is a schematic diagram of a hardware architecture of an electronic apparatus 6 according to Embodiment 3 of the application. In this embodiment, the electronic apparatus 6 may include but is not limited to a memory 61, a processor 62, and a network interface 63 that may be communicatively connected to each other by using a system bus. It should be noted that FIG. 6 merely shows the electronic apparatus 6 with the components 61 to 63. However, it should be understood that implementation of all the shown components is not required, and more or fewer components may alternatively be implemented. In this embodiment, the electronic apparatus 6 may be the client.

The memory 61 includes at least one type of readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 61 may be an internal storage unit of the electronic apparatus 6, for example, a hard disk or a memory of the electronic apparatus 6. In some other embodiments, the memory 61 may alternatively be an external storage device of the electronic apparatus 6, for example, a removable hard disk, a smart media card (SMC), a secure digital (SD) card, or a flash card that is disposed on the electronic apparatus 6. Certainly, the memory 61 may alternatively include both an internal storage unit of the electronic apparatus 6 and an external storage device of the electronic apparatus 6. In this embodiment, the memory 61 is usually configured to store an operating system and various types of application software that are installed in the electronic apparatus 6, for example, computer-readable instructions of a hybrid playback processing system 60. In addition, the memory 61 may be further configured to temporarily store various types of data that have been output or are to be output.

The processor 62 may be a central processing unit (CPU), a controller, a microcontroller, a microprocessor, or another data processing chip in some embodiments. The processor 62 is usually configured to control an overall operation of the electronic apparatus 6. In this embodiment, the processor 62 is configured to run the computer-readable instructions stored in the memory 61 or process data, for example, run the hybrid play back processing system 60.

The network interface 63 may include a wireless network interface or a wired network interface, and the network interface 63 is usually configured to establish a communication connection between the electronic apparatus 6 and another electronic device.

### Embodiment 4

FIG. 7 is a schematic diagram of modules in a hybrid playback processing system 60 according to Embodiment 4 of the application. The hybrid playback processing system 60 may be divided into one or more program modules. The one or more program modules are stored in a storage medium and executed by one or more processors, to complete this embodiment of the application. The program modules in this embodiment of the application is a series of computer-readable instruction segments that can complete a specific function. The following specifically describes a function of each program module in this embodiment.

In this embodiment, the hybrid playback processing system 60 includes:
a management module 600, configured to abstract each service video into basic video data according to a preset rule, generate a playback task queue, and submit the playback task queue to a playback module 602; and
the playback module 602 (a player), providing a playback task definition and a task submission interface. The management module 600 obtains the playback task definition provided by the player, abstracts, according to a rule corresponding to the playback task definition, each service video that needs to be played into basic video data, generates a playback task queue, and then submits the playback task queue to the player by using the interface. The basic video data includes no service logic.

The play back module 602 is configured to: control the player to read a current first play back task from the play back task queue, obtain first basic video data corresponding to the first playback task, load a corresponding first panel instance from a panel cache pool according to a service type to which a first service video corresponding to the first playback task belongs, and play the first basic video data by using the first panel instance.

The play back module 602 is further configured to: when a second playback task is switched to, reset the first basic video data in the player, obtain second basic video data corresponding to the second playback task, load a corresponding second panel instance from the panel cache pool according to a service type to which a second service video corresponding to the second play back task belongs, and play the second basic video data by using the second panel instance.

In this embodiment, when playing a service video of a service type for a first time, the player creates a panel instance corresponding to the service type, caches the panel instance in the panel cache pool, and stores a mapping relationship between the service type and the panel instance. Every time a play back task is switched to, panel instance information corresponding to the service type is queried from the mapping relationship, and then the panel instance is found and loaded from the panel cache pool according to the queried information.

It should be noted that the player creates only one player instance in a hybrid play back process, consumes a playback task in the playback task queue, and plays, in the player instance, the basic video data corresponding to the service video of each service type by using the panel instance corresponding to the service type.

When playback task switching occurs, old data in the player is reset and new data is submitted. For example, when the first service video is switched to the second service video, the first basic video data corresponding to the first service video in the player is reset, and the second basic video data corresponding to the second service video is submitted. Specifically, the switching may be manually switching a video by a user, automatically playing a next video in a playlist, or the like.

Preferably, the player is a card-style player, and plays the service video by using a small-window view.

In an optional embodiment, the management module 600 is further configured to receive a preset operation of the user, and add or delete a small-window view corresponding to the player (that is, create or delete a card-style player) on a current display interface according to the preset operation.

In an optional embodiment, when deleting the small-window view, the management module 600 is further configured to clear the panel instance cached in the panel cache pool to free up storage space.

In an optional embodiment, the management module 600 is further configured to: when the player triggers a status update, transmit a status update message to a currently bound service party, wherein the currently bound service party is a service party corresponding to a service video currently being played.

The management module 600 is further responsible for interaction with each service party. When the player plays a video of a service type, the service party performs monitoring and registers with the management module 600 to form a binding relationship with the player. When the player triggers a specific status update (pause, initial playing, a playback failure due to a data error, or the like), the management module 600 sends the status update message of the player to the currently bound service party.

When a video of another service type is switched to, an old service proxy is unbound in a timely manner and the service party is notified (that the status update message is no longer sent to the service party), and then a new service proxy is bound, to avoid confusion in play back control rights.

Specifically, when the first service video is played, a service party corresponding to the first service video is bound, and the status update message of the player is sent to the service party. When playing the first service video is switched to playing the second service video, the service party corresponding to the first service video is unbound from the player, and the player is bound to a service party corresponding to the second service video.

According to the hybrid play back processing system provided in this embodiment, the player and service data can be deeply decoupled, the service video is abstracted into most basic data, which is submitted to the player, and only one player instance is created. Corresponding service videos are played by using panel instances corresponding to different service types, so that hybrid play back of different playback modes (videos of different service types) and player reusing are implemented without switching between different pages and scenarios, thereby ensuring seamless switching between a plurality of services and ensuring performance, and implementing best user experience. In addition, interactive scheduling between the player and the service party can be effectively managed, and the status update message of the player is accurately transmitted to the currently bound service party. In addition, when service switching occurs, an old service party is unbound in a timely manner and a new service party is bound, to avoid confusion in playback control rights.

### Embodiment 5

The application further provides another implementation, that is, provides a computer-readable storage medium, storing computer-readable instructions, and the computer-readable instructions are capable of being executed by at least one processor to enable the at least one processor to perform the following steps:
abstracting each service video into basic video data according to a preset rule, generating a playback task queue, and submitting the play back task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

It should be noted that in this specification, the term “include”, “comprise”, or any other variant thereof is intended to cover non-exclusive inclusion, so that a process, method, article, or apparatus that includes a series of elements includes those elements and other elements that are not explicitly listed or elements inherent to the process, method, article, or apparatus. In the absence of more restrictions, the element defined with the statement “includes one ...” does not exclude the existence of another identical element in the process, method, article, or apparatus that includes the element.

The serial numbers of the foregoing embodiments of the application are merely for illustrative purposes, and are not intended to indicate priorities of the embodiments.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using computer-readable instructions that can be executed by the computing apparatus. Therefore, the modules or steps may be stored in a storage apparatus for execution by the computing apparatus. In addition, in some cases, the shown or described steps may be performed in a sequence different from the sequence herein. Alternatively, the modules or steps may be separately made into integrated circuit modules, or a plurality of modules or steps in the modules or steps may be made into a single integrated circuit module for implementation. In this way, a combination of any specific hardware and software is not limited in the embodiments of the application.

The foregoing descriptions are merely preferred embodiments in the embodiments of the application, and are not intended to limit the patent scope of the embodiments of this application. Any equivalent structure or equivalent procedure change that is made by using the content of the specification and the accompanying drawings of the embodiments of the application or that is directly or indirectly applied to other related technical fields shall also fall within the patent protection scope of the embodiments of the application.

1. A hybrid playback processing method, comprising:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

2. The hybrid playback processing method according to claim 1, wherein the abstracting each service video into basic video data according to a preset rule comprises:
obtaining a playback task definition provided by the player, and abstracting the service video into the basic video data according to a rule corresponding to the playback task definition, wherein the basic video data comprises no service logic.

3. The hybrid playback processing method according to claim 1, further comprising:
when playing a service video of a service type for a first time, creating, by the player, a panel instance corresponding to the service type, caching the panel instance in the panel cache pool, and storing a mapping relationship between the service type and the panel instance.

4. The hybrid playback processing method according to claim 3, wherein the loading a corresponding first panel instance from a panel cache pool according to a service type to which a first service video corresponding to the first playback task belongs comprises:
querying panel instance information corresponding to the service type from the mapping relationship, and finding and loading the first panel instance from the panel cache pool according to queried information.

5. The hybrid playback processing method according to claim 1, wherein the player is configured to create only one player instance, and play, in the player instance, the basic video data corresponding to the service video of the service type by using the panel instance corresponding to each service type.

6. The hybrid playback processing method according to claim 1, further comprising:
when the player triggers a status update, transmitting a status update message to a currently bound service party, wherein the currently bound service party is a service party corresponding to a service video currently being played.

7. The hybrid playback processing method according to claim 6, further comprising:
when playing the first service video is switched to playing the second service video, unbinding a service party corresponding to the first service video from the player, and binding the player to a service party corresponding to the second service video.

8. The hybrid playback processing method according to claim 1, wherein the player is configured to be a card-style player, and play the service video by using a small-window view.

9. The hybrid playback processing method according to claim 8, further comprising:
receiving a preset operation of a user, and adding or deleting a small-window view corresponding to the player in a current display interface according to the preset operation.

10. The hybrid playback processing method according to claim 9, further comprising:
when the small-window view corresponding to the player is deleted, clearing panel instances cached in the panel cache pool.

11. A hybrid playback processing system, comprising:
a management module, configured to abstract each service video into basic video data according to a preset rule, generate a playback task queue, and submit the playback task queue to a player; and
a playback module, configured to: control the player to read a current first playback task from the playback task queue, obtain first basic video data corresponding to the first playback task, load a corresponding first panel instance from a panel cache pool according to a service type to which a first service video corresponding to the first playback task belongs, and play the first basic video data by using the first panel instance, wherein
the playback module is further configured to: when a second playback task is switched to, reset the first basic video data in the player, obtain second basic video data corresponding to the second playback task, load a corresponding second panel instance from the panel cache pool according to a service type to which a second service video corresponding to the second playback task belongs, and play the second basic video data by using the second panel instance.

12. An electronic apparatus, comprising a memory, a processor, and computer-readable instructions stored in the memory and capable of running on the processor, wherein the computer-readable instructions are executed by the processor to implement the following steps:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.

13. The electronic apparatus according to claim 12, wherein the abstracting each service video into basic video data according to a preset rule comprises:
obtaining a playback task definition provided by the player, and abstracting the service video into the basic video data according to a rule corresponding to the playback task definition, wherein the basic video data comprises no service logic.

14. The electronic apparatus according to claim 12, wherein the computer-readable instructions are executed by the processor to further implement the following step:
when playing a service video of a service type for a first time, creating, by the player, a panel instance corresponding to the service type, caching the panel instance in the panel cache pool, and storing a mapping relationship between the service type and the panel instance.

15. The electronic apparatus according to claim 14, wherein the loading a corresponding first panel instance from a panel cache pool according to a service type to which a first service video corresponding to the first playback task belongs comprises:
querying panel instance information corresponding to the service type from the mapping relationship, and then finding and loading the first panel instance from the panel cache pool according to the queried information.

16. The electronic apparatus according to claim 12, wherein the player is configured to create only one player instance, and play, in the player instance, the basic video data corresponding to the service video of the service type by using the panel instance corresponding to each service type.

17. The electronic apparatus according to claim 12, wherein the computer-readable instructions are executed by the processor to further implement the following step:
when the player triggers a status update, transmitting a status update message to a currently bound service party, wherein the currently bound service party is a service party corresponding to a service video currently being played.

18. The electronic apparatus according to claim 17, wherein the computer-readable instructions are executed by the processor to further implement the following step:
when playing the first service video is switched to playing the second service video, unbinding a service party corresponding to the first service video from the player, and binding the player to a service party corresponding to the second service video.

19. The electronic apparatus according to claim 12, wherein the player is configured to be a card-style player, and play the service video by using a small-window view.

20. A non-transitory computer-readable storage medium, storing computer-readable instructions, wherein the computer-readable instructions are executed by a processor to implement the following steps:
abstracting each service video into basic video data according to a preset rule, generating a playback task queue, and submitting the playback task queue to a player;
reading, by the player, a current first playback task from the playback task queue, obtaining first basic video data corresponding to the first playback task, loading a corresponding first panel instance from a panel cache pool according to a service type to which a first service video corresponding to the first playback task belongs, and playing the first basic video data by using the first panel instance; and
when a second playback task is switched to, resetting the first basic video data in the player, obtaining second basic video data corresponding to the second playback task, loading a corresponding second panel instance from the panel cache pool according to a service type to which a second service video corresponding to the second playback task belongs, and playing the second basic video data by using the second panel instance.
